(19) United States
(12) Patent Application Publication
(10) Pub. No.: US 2021/0133415 A1
(43) Pub. Date: May 6, 2021

(54) DISPLAY DEVICE

(71) Applicant: Samsung Display Co., Ltd., Yongin-si (KR)

(72) Inventor: Jeong Kyoo KIM, Yongin-si (KR)

(21) Appl. No.: 17/005,321

(22) Filed: Aug. 28, 2020

(30) Foreign Application Priority Data
Oct. 31, 2019 (KR) 10-2019-0137849

(51) Int. Cl. G06K 9/00; G06T 11/00; G09G 3/20; G06F 3/043; G06F 21/32; G06F 16/583

(52) U.S. Cl. CPC G06K 9/0002; G06T 11/00; G09G 3/20; G06F 16/5854; G06K 9/00087; G06F 21/32; G06F 3/043

(57) ABSTRACT

A display device includes a display panel to display an image; an ultrasonic sensor to sense an object interacting with the display panel using an ultrasonic signal; an ultrasonic sensor controller to receive an instruction signal to control an operation of the ultrasonic sensor, and to output a sensing value corresponding to the sensed object; and a central controller to output the instruction signal according to one of an authentication mode and an authentication completion mode, and to control the display panel based on the sensing value. In the authentication mode, the central controller generates an image of the object based on the sensing value, and determines whether the object corresponds to a registered user based on a comparison of the image with a predefined image. In the authentication completion mode, the central controller recognizes a point touched on the display panel by the object based on the sensing value.

### CROSS-REFERENCE TO RELATED APPLICATIONS

This application claims priority to and the benefit of Korean Patent Application No. 10-2019-0137849, filed Oct. 31, 2019, which is hereby incorporated by reference for all purposes as if fully set forth herein.

### BACKGROUND

### Field

Exemplary embodiments generally relate to a display device.

### Discussion

An electroluminescent display device is roughly classified into an inorganic light emitting display device or an organic light emitting display device according to a material of a light emitting layer. An organic light emitting display device of an active matrix type includes an organic light emitting diode (hereinafter, referred to as an “OLED”) that emits light by itself, and has advantages in which a response speed is fast, and light emission efficiency, luminance, and a viewing angle are large.

A driving circuit of a flat panel display device may include a data driving circuit that supplies a data signal to data lines, a scan driving circuit that supplies a gate signal (or a scan signal) to gate lines (or scan lines), and/or the like. The scan driving circuit may be directly formed on the same substrate together with circuit elements of an active area configuring a screen of the flat panel display device. The circuit elements of the active area configure a pixel circuit formed in each of pixels, which may be defined in a matrix form or arrangement, by the data lines and the scan lines of a pixel array. Each of the circuit elements and the scan driving circuit of the active area includes a plurality of transistors.

In some instances, a display device may further include a touch sensor mounted on the display device so that an application, other program(s), and/or the like, may be executed by a touch operation of a user. To reinforce security, the display device may further include an ultrasonic sensor and/or the like to sense biometric information of the user. It is noted, however, that when the display device further includes a touch sensor, an ultrasonic sensor, and/or the like, it is difficult to miniaturize and lighten the display device, and the display device may malfunction due to inclusion of a number of electronic parts. Therefore, a technology for a display device capable of performing all of a touch recognition function, a security function, and/or the like, with, for instance, an ultrasonic sensor is desired.

The above information disclosed in this section is only for understanding the background of the inventive concepts, and, therefore, may contain information that does not form prior art.

### SUMMARY

Some aspects provide a display device capable of reducing cost by performing both a security operation and a touch recognition operation with only an ultrasonic sensor without a separate touch sensor.

Some aspects are capable of providing a display device that is convenient and portable to a user by miniaturizing and lightening the display device.

Additional aspects will be set forth in the detailed description which follows, and, in part, will be apparent from the disclosure, or may be learned by practice of the inventive concepts.

According to some aspects, a display device includes a display panel, an ultrasonic sensor, an ultrasonic sensor controller, and a central controller. The display panel is configured to display an image. The ultrasonic sensor is configured to sense an object interacting with the display panel using an ultrasonic signal. The ultrasonic sensor controller is configured to receive an instruction signal to control an operation of the ultrasonic sensor, and to output a sensing value corresponding to the sensed object. The central controller is configured to output the instruction signal according to one of an authentication mode and an authentication completion mode, and to control the display panel based on the sensing value. In response to a mode being the authentication mode, the central controller is further configured to generate a first image of the object based on the sensing value, and to determine whether the object corresponds to a user registered to the display device based on a comparison of the first image with a predefined second image. In response to the mode being the authentication completion mode, the central controller is further configured to recognize a point touched on the display panel by the object based on the sensing value.

According to some aspects, an apparatus includes at least one processor and at least one memory. The at least one memory includes a predefined image and one or more sequences of one or more instructions that, in response to being executed by the at least one processor, cause the apparatus at least to: receive an ultrasonic signal in association with one of an authentication mode and an authentication completion mode; sense interaction of an object with the apparatus based on reception of the ultrasonic signal; generate a sensing value corresponding to the interaction; and generate a display panel control signal based on the sensing value. In association with the authentication mode, the apparatus is further caused at least to generate an image of the object based on the sensing value, and to determine whether the object corresponds to a user registered to the apparatus based on a comparison of the image with the predefined image. In association with the authentication completion mode, the apparatus is further caused at least to recognize a point of interaction of the object with the apparatus based on the sensing value.

According to some exemplary embodiments, a display device may be capable of reducing cost by performing both a security operation and a touch recognition operation with only an ultrasonic sensor without a touch sensor. In addition, some exemplary embodiments may provide a display device that is convenient and portable to a user by miniaturizing and lightening the display device.

The foregoing general description and the following detailed description are exemplary and explanatory and are intended to provide further explanation of the claimed subject matter.

### BRIEF DESCRIPTION OF THE DRAWINGS

The accompanying drawings, which are included to provide a further understanding of the inventive concepts, and are incorporated in and constitute a part of this specification, illustrate exemplary embodiments of the inventive concepts, and, together with the description, serve to explain principles of the inventive concepts. In the drawings:

FIG. 1 is a configuration diagram schematically illustrating a display device according to some exemplary embodiments;

FIG. 2 is a block diagram schematically illustrating a display panel according to some exemplary embodiments;

FIG. 3 is an exploded view of an ultrasonic sensor according to some exemplary embodiments;

FIG. 4 is a diagram illustrating transmission and reception of ultrasonic signals according to some exemplary embodiments;

FIG. 5 is a diagram illustrating transmission and reception of ultrasonic signals when an object exists in FIG. 4 according to some exemplary embodiments;

FIG. 6 is a block diagram illustrating an ultrasonic sensor controller and a pixel sensor according to some exemplary embodiments;

FIG. 7 is a flowchart illustrating a user authentication method in an authentication mode according to some exemplary embodiments;

FIG. 8 is a diagram illustrating display of an authentication induction image according to some exemplary embodiments;

FIG. 9 is a diagram illustrating display of an authentication induction image according to some exemplary embodiments;

FIG. 10 is a flowchart illustrating a touch recognition method in an authentication completion mode according to some exemplary embodiments;

FIGS. 11 and 12 are diagrams illustrating a touch being recognized and touch coordinates being generated according to various exemplary embodiments; and

FIG. 13 is a diagram illustrating a central controller according to some exemplary embodiments.

### DETAILED DESCRIPTION OF SOME EXEMPLARY EMBODIMENTS

In the following description, for the purposes of explanation, numerous specific details are set forth in order to provide a thorough understanding of various exemplary embodiments. As used herein, the terms “embodiments” and “implementations” are used interchangeably and are non-limiting examples employing one or more of the inventive concepts disclosed herein. It is apparent, however, that various exemplary embodiments may be practiced without these specific details or with one or more equivalent arrangements. In other instances, well-known structures and devices are shown in block diagram form in order to avoid unnecessarily obscuring various exemplary embodiments. Further, various exemplary embodiments may be different, but do not have to be exclusive. For example, specific shapes, configurations, and characteristics of an exemplary embodiment may be used or implemented in another exemplary embodiment without departing from the inventive concepts.

Unless otherwise specified, the illustrated exemplary embodiments are to be understood as providing exemplary features of varying detail of some exemplary embodiments. Therefore, unless otherwise specified, the features, components, modules, layers, films, panels, regions, aspects, etc. (hereinafter individually or collectively referred to as an “element” or “elements”), of the various illustrations may be otherwise combined, separated, interchanged, and/or rearranged without departing from the inventive concepts.

The use of cross-hatching and/or shading in the accompanying drawings is generally provided to clarify boundaries between adjacent elements. As such, neither the presence nor the absence of cross-hatching or shading conveys or indicates any preference or requirement for particular materials, material properties, dimensions, proportions, commonalities between illustrated elements, and/or any other characteristic, attribute, property, etc., of the elements, unless specified. Further, in the accompanying drawings, the size and relative sizes of elements may be exaggerated for clarity and/or descriptive purposes. As such, the sizes and relative sizes of the respective elements are not necessarily limited to the sizes and relative sizes shown in the drawings. When an exemplary embodiment may be implemented differently, a specific process order may be performed differently from the described order. For example, two consecutively described processes may be performed substantially at the same time or performed in an order opposite to the described order. Also, like reference numerals denote like elements.

When an element, such as a layer, is referred to as being “on,” “connected to,” or “coupled to” another element, it may be directly on, connected to, or coupled to the other element or intervening elements may be present. When, however, an element is referred to as being “directly on,” “directly connected to,” or “directly coupled to” another element, there are no intervening elements present. Other terms and/or phrases used to describe a relationship between elements should be interpreted in a like fashion, e.g., “between” versus “directly between,” “adjacent” versus “directly adjacent,” “on” versus “directly on,” etc. Further, the term “connected” may refer to physical, electrical, and/or fluid connection. For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. As used herein, the term “and/or” includes any and all combinations of one or more of the associated listed items.

Although the terms “first,” “second,” etc. may be used herein to describe various elements, these elements should not be limited by these terms. These terms are used to distinguish one element from another element. Thus, a first element discussed below could be termed a second element without departing from the teachings of the disclosure.

Spatially relative terms, such as “beneath,” “below,” “under,” “lower,” “above,” “upper,” “over,” “higher,” “side” (e.g., as in “sidewall”), and/or the like, may be used herein for descriptive purposes, and, thereby, to describe one element's relationship to another element(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof. It is also noted that, as used herein, the terms “substantially,” “about,” and other similar terms, are used as terms of approximation and not as terms of degree, and, as such, are utilized to account for inherent deviations in measured, calculated, and/or provided values that would be recognized by one of ordinary skill in the art.

Various exemplary embodiments are described herein with reference to sectional views, isometric views, perspective views, plan views, and/or exploded illustrations that are schematic illustrations of idealized exemplary embodiments and/or intermediate structures. As such, variations from the shapes of the illustrations as a result of, for example, manufacturing techniques and/or tolerances, are to be expected. Thus, exemplary embodiments disclosed herein should not be construed as limited to the particular illustrated shapes of regions, but are to include deviations in shapes that result from, for instance, manufacturing. To this end, regions illustrated in the drawings may be schematic in nature and shapes of these regions may not reflect the actual shapes of regions of a device, and, as such, are not intended to be limiting.

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and will not be interpreted in an idealized or overly formal sense, unless expressly so defined herein.

As customary in the field, some exemplary embodiments are described and illustrated in the accompanying drawings in terms of functional blocks, units, and/or modules. Those skilled in the art will appreciate that these blocks, units, and/or modules are physically implemented by electronic (or optical) circuits, such as logic circuits, discrete components, microprocessors, hard-wired circuits, memory elements, wiring connections, and/or the like, which may be formed using semiconductor-based fabrication techniques or other manufacturing technologies. In the case of the blocks, units, and/or modules being implemented by microprocessors or other similar hardware, they may be programmed and controlled using software (e.g., microcode) to perform various functions discussed herein and may optionally be driven by firmware and/or software. It is also contemplated that each block, unit, and/or module may be implemented by dedicated hardware, or as a combination of dedicated hardware to perform some functions and a processor (e.g., one or more programmed microprocessors and associated circuitry) to perform other functions. Also, each block, unit, and/or module of some exemplary embodiments may be physically separated into two or more interacting and discrete blocks, units, and/or modules without departing from the inventive concepts. Further, the blocks, units, and/or modules of some exemplary embodiments may be physically combined into more complex blocks, units, and/or modules without departing from the inventive concepts.

Exemplary embodiments may be applied to (or in association with) various display devices, such as an organic light emitting display device, an inorganic light emitting display device, a quantum dot light emitting device, a micro light emitting device, a nano light emitting device, a liquid crystal display device, a field emission display device, an electrophoretic device, an electrowetting device, etc.

Hereinafter, various exemplary embodiments will be explained in detail with reference to the accompanying drawings.

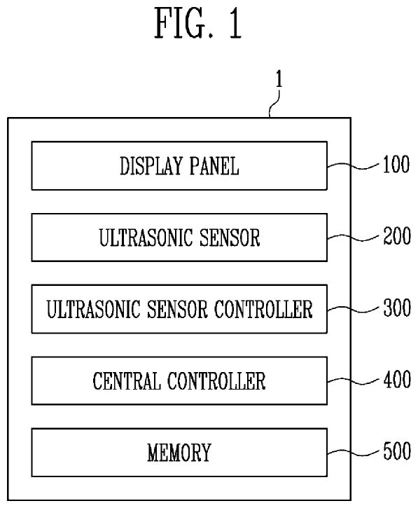

FIG. 1 is a configuration diagram schematically illustrating a display device according to some exemplary embodiments.

Referring to FIG. 1, a display device 1 according to some exemplary embodiments may include an authentication mode and an authentication completion mode. The authentication mode may refer to a mode for authenticating whether an object to use the display device 1, for example, a user is a registered user registered in (or to) the display device 1. The authentication completion mode may refer to a mode in which authentication is completed and the user may use the display device 1. The object may refer to a portion of a body of the user, e.g., a finger including a fingerprint, an iris, a face, and/or the like, but embodiments are not limited thereto. Hereinafter, for convenience, the description will be given based on an exemplary embodiment in which the object is a finger of a user.

The display device 1 may include a display panel 100, an ultrasonic sensor 200, an ultrasonic sensor controller 300, a central controller 400, a memory 500, and/or the like.

The display panel 100 may display an image. For instance, the display panel 100 may receive input signals to display the image, and display the image at an appropriate driving timing according to the input signal.

The display panel 100 according to some exemplary embodiments may be implemented on a flexible substrate that is, for instance, foldable, may be implemented on a rigid substrate that is not folded, or may be implemented on a hybrid substrate that is rigid in at least one area and foldable in at least one other area.

The ultrasonic sensor 200 may sense an object existing on (or interacting with) the display panel 100 using an ultrasonic signal.

An operation of the ultrasonic sensor 200 may be controlled by the ultrasonic sensor controller 300, and the ultrasonic sensor 200 may output an ultrasonic signal reflected from the object, an electric signal, other current, and/or the like, corresponding thereto to the ultrasonic sensor controller 300.

The ultrasonic sensor controller 300 may receive an instruction signal from the central controller 400 to control the operation of the ultrasonic sensor 200 and output a sensing value corresponding to the sensed object. For instance, the ultrasonic sensor controller 300 may control the operation of the ultrasonic sensor 200 to adjust a timing at which the ultrasonic sensor 200 transmits the ultrasonic signal, a transmission position, and/or the like, according to a characteristic of the input instruction signal, and may output the sensing value based on the ultrasonic signal reflected from the object.

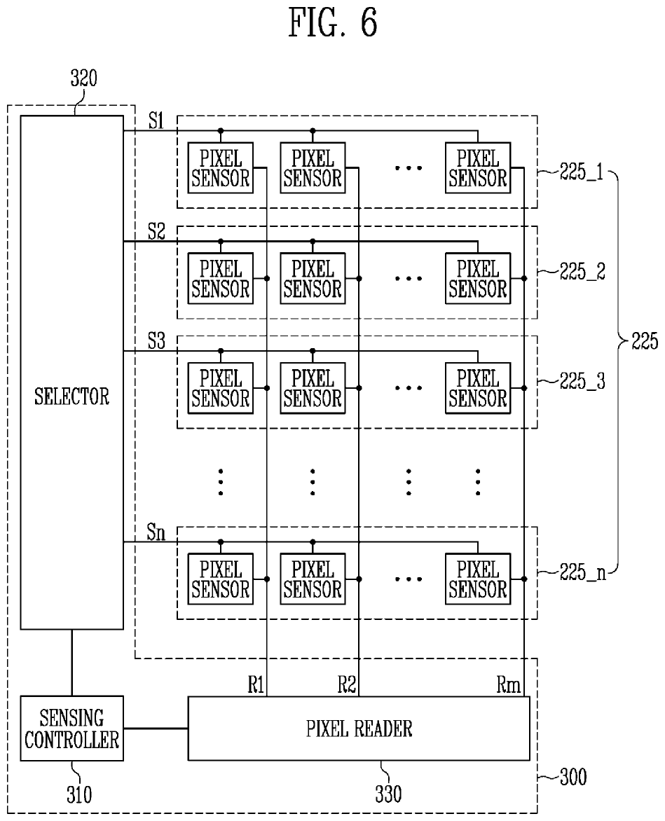

In some embodiments, the ultrasonic sensor controller 300 may control the operation of the ultrasonic sensor 200 differently according to the authentication mode and the authentication completion mode that may be determined according to the characteristic of the instruction signal received by the ultrasonic sensor controller 300. The sensing value may refer to a value obtained by digitizing the ultrasonic signal that is an analog signal. A more detailed description thereof will be described later with reference to FIG. 6.

The central controller 400 may output the instruction signal according to any one mode of the authentication mode and the authentication completion mode, and perform display control on the display panel 100 based on the sensing value.

The display control may refer to control for displaying an image on the display panel 100 for inducing authentication of the user who wants to use the display device 1. For example, the display control may mean that a fingerprint image is displayed on the display panel 100 in the authentication mode. However, embodiments are not limited thereto.

In some embodiments, the display control may refer to control for visualizing a function performed by software, such as an application or a program, through the display panel 100 according to a touch of an authenticated user in the authentication completion mode. For example, when the authenticated user touches an icon indicating a playback program that plays a video, music, or the like, on the display panel 100 and the playback program performs a playback function, the display control may refer to control for displaying a video, an image, or the like, being displayed on the display panel 100. However, embodiments are not limited thereto.

The central controller 400 may identify whether the mode of the display device 1 is the authentication mode or the authentication completion mode according to a display state of the display device 1. For example, when the state of the display device 1 is a state in which an image related to an application is displayed, the central controller 400 identifies that the current mode of the display device 1 is the authentication completion mode. As another example, when the display device 1 to which a locking function is set is in a standby state, the central controller 400 identifies that the current mode of the display device 1 is the authentication mode. However, embodiments are not limited thereto.

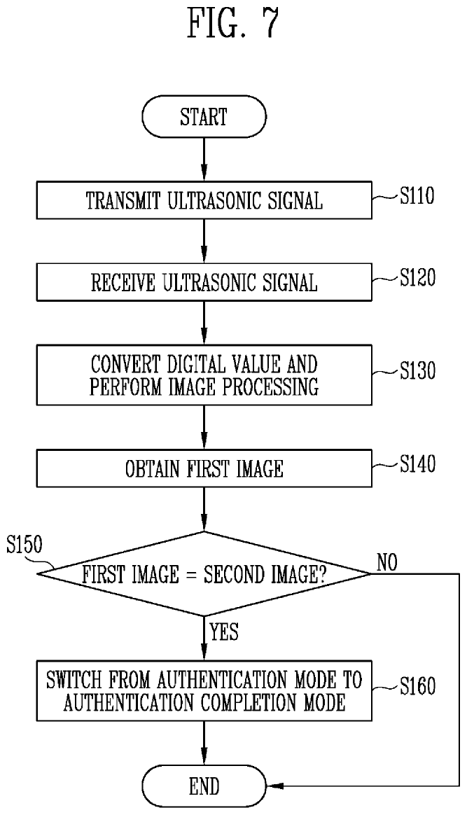

When the mode is the authentication mode, the central controller 400 may generate a first image of the object based on the sensing value, and compare the first image with a second image previously stored in a memory 500, to authenticate whether the object is the user registered in (or to) the display device 1. A method of authenticating whether the object is the user registered in the display device 1 will be described later with reference to FIG. 7.

The first image may include first biometric information, and the second image may include second biometric information of the user registered in the display device 1. The first and second biometric information may be fingerprint information of the user. However, embodiments are not limited thereto, and the biometric information may be iris information, face information, and/or the like.

As an embodiment, the central controller 400 may identify whether the display panel 100 is touched at least once by the object in the authentication mode. When the display panel 100 is touched by the object, the central controller 400 may generate the first image based on the sensing value.

When the mode is the authentication completion mode, the central controller 400 may recognize a position of a point touched by the object on the display panel 100 based on the sensing value. For instance, the central controller 400 may compare the sensing value obtained by digitizing the ultrasonic signal that is an analog signal with a coordinate value stored in the memory 500, and determine a coordinate value corresponding to the above-described sensing value.

The central controller 400 may refer to an application processor, a central processing unit (CPU), a graphics processing unit (GPU), and/or the like. However, embodiments are not limited thereto.

The memory 500 may store data for the central controller 400 to perform a user authentication operation, a touch recognition operation, a display control operation, and/or the like, as, for instance, a lookup table. Embodiments, however, are not limited thereto.

For example, the memory 500 may store first data related to the biometric information for the central controller 400 to perform the user authentication operation. As another example, the memory 500 may store second data related to the coordinate information on the display panel 100 for the central controller 400 to perform the touch recognition operation. As still another example, the memory 500 may store third data related to display control information for the central controller 400 to perform the display control operation. As still another example, the memory 500 may store data related to movement speed information of the ultrasonic signal.

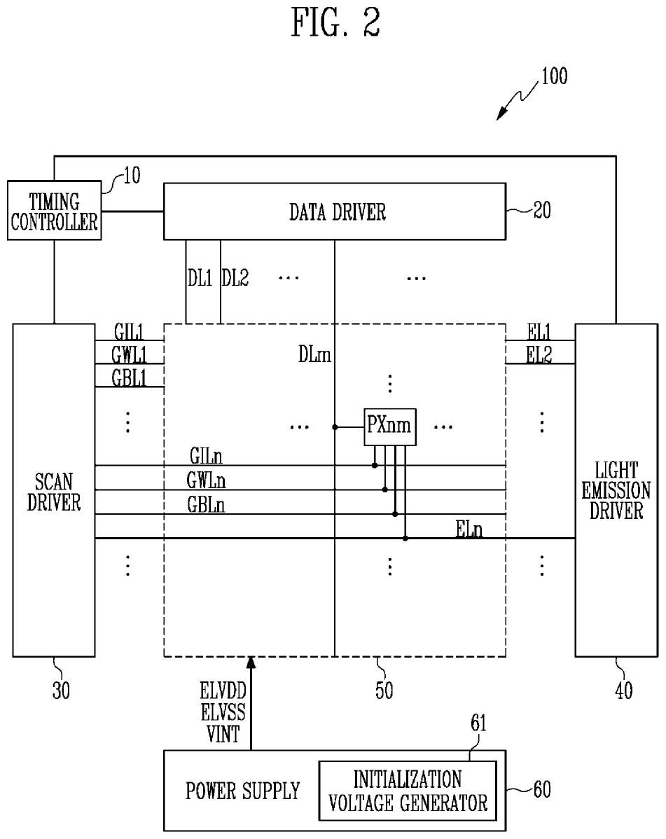

FIG. 2 is a block diagram schematically illustrating the display panel 100 according to some exemplary embodiments.

Referring to FIG. 2, the display panel 100 includes a timing controller 10, a data driver 20, a scan driver 30, a light emission driver 40, a display unit 50, and a power supply 60.

The timing controller 10 may generate signals for the display panel 100 by receiving an external input signal for an image frame from an external processor. For example, the timing controller 10 may provide grayscale values and control signals to the data driver 20. In addition, the timing controller 10 may provide a clock signal, a scan start signal, and/or the like to the scan driver 30. In addition, the timing controller 10 may provide a clock signal, a light emission stop signal, and/or the like to the light emission driver 40.

The data driver 20 may generate data voltages to be provided to data lines DL1, DL2, and DLm using the grayscale values and the control signals received from the timing controller 10. For example, the data driver 20 may sample the grayscale values using a clock signal, and may apply the data voltages corresponding to the grayscale values to the data lines DL1, DL2, and DLm in a unit of a pixel row (for example, pixels connected to the same scan line). Here, m may be a natural number.

The scan driver 30 may receive the clock signal, the scan start signal, and/or the like from the timing controller 10 to generate scan signals to be provided to scan lines GIL1, GWL1, GBL1, GILn, GWLn, and GBLn. Here, n may be a natural number.

The scan driver 30 may include a plurality of sub-scan drivers. For example, a first sub-scan driver may provide scan signals for first scan lines GIL1 and GILn, a second sub-scan driver may provide scan signals for second scan lines GWL1 and GWLn, and a third sub-scan driver may provide scan signals for third scan lines GBL1 and GBLn. Each of the sub-scan drivers may include a plurality of scan stages connected in a form of a shift register. For example, the scan signals may be generated by sequentially transferring a pulse of a turn-on level of the scan start signal supplied to a scan start line to a next scan stage.

The light emission driver 40 may receive the clock signal, the light emission stop signal, and/or the like from the timing controller 10 to generate light emission signals to be provided to light emission lines EL1 EL2, and ELn. For example, the light emission driver 40 may sequentially provide light emission signals having pulses of a turn-off level to the light emission lines EL1 EL2, and ELn. For example, the light emission driver 40 may be configured in a form of a shift register, and may generate the light emission signals by sequentially transferring a pulse of a turn-off level of the light emission stop signal to a next light emission stage under control of the clock signal.

The display unit 50 includes pixels, such as pixel PXnm. For example, the pixel PXnm may be connected to one corresponding data line DLm, a plurality of scan lines GILn, GWLn, and GBLn, and one light emission line ELn. However, the numbers of the data line DLm, the scan lines GILn, GWLn, and GBLn, and the light emission line ELn corresponding to the pixel PXnm are not limited to those shown in the drawing.

The plurality of pixels PXnm may define a light emitting area that emits light of a plurality of colors. For example, the plurality of pixels PXnm may define a light emitting area that emits light of red, green, and blue, but embodiments are not limited thereto. As an embodiment, the pixel PXnm includes a plurality of transistors and at least one capacitor. In some other embodiments, in the pixel PXnm, at least some of the plurality of transistors may be a double gate transistor having two gate electrodes.

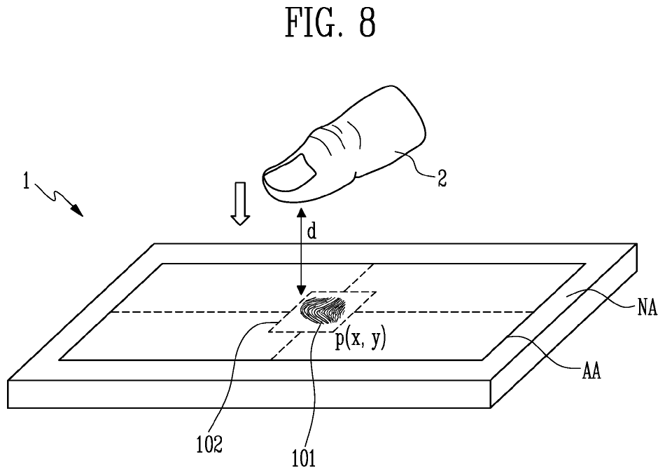

The display unit 50 may define a display area AA (see, e.g., FIG. 8) including the light emitting area that emits light of a plurality of colors defined by the pixels PXnm.

The power supply 60 may receive an external input voltage and provide a power voltage to an output terminal by converting the external input voltage. For example, the power supply 60 generates a first power voltage ELVDD and a second power voltage ELVSS based on the external input voltage. For the purposes of this disclosure, a first power and a second power may be powers having voltage levels relative to each other. For example, a voltage level of the first power may be higher than a voltage level of the second power, but embodiments are not limited thereto. The power supply 60 may provide an initialization voltage VINT for initializing a gate electrode of a driving transistor and/or an anode of a light emitting diode for each pixel PXnm.

The power supply 60 may receive an external input voltage from a battery or the like, and boost the external input voltage to generate a power voltage that is higher than the external input voltage. For example, the power supply 60 may be configured as a power management integrated chip (PMIC). For example, the power supply 60 may be configured as an external direct current (DC)/DC integrated chip (IC).

The power supply 60 may include an initialization voltage generator 61. The initialization voltage generator 61 may control a voltage level of the initialization voltage VINT provided for each pixel PXnm. For instance, the initialization voltage generator 61 may control the voltage level of the initialization voltage VINT provided to each pixel PXnm to have a plurality of voltage levels rather than an always constant voltage level. It may be understood that the initialization voltage VINT, which will be described later in more detail, is controlled by the initialization voltage generator 61.

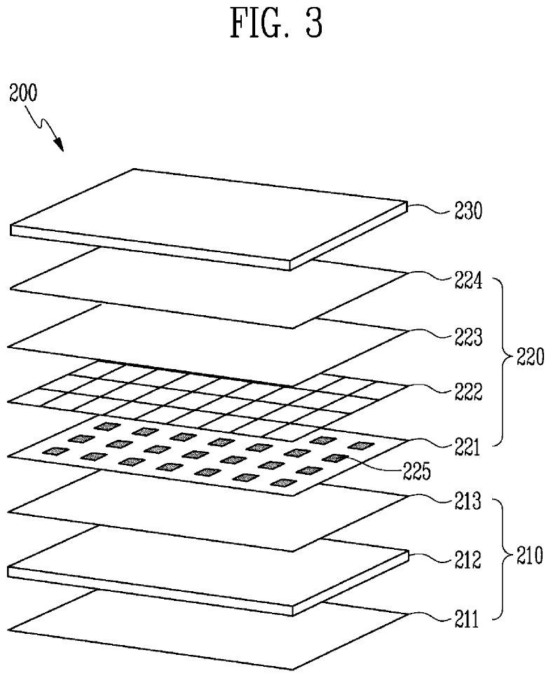

FIG. 3 is an exploded view of the ultrasonic sensor 200 according to some exemplary embodiments.

Referring to FIG. 3, the ultrasonic sensor 200 according to some exemplary embodiments may include a transmitter 210, a receiver 220, a platen 230, and/or the like.

The transmitter 210 may transmit an ultrasonic signal and may be a piezoelectric transmitter capable of generating ultrasonic signals. However, embodiments are not limited thereto.

The transmitter 210 may be a plane wave generator including a piezoelectric transmission layer 212, which may be flat. For example, the transmitter 210 may apply a voltage to the piezoelectric transmission layer 212 and generate the ultrasonic signals by expanding or contracting the piezoelectric transmission layer 212 according to the applied voltage. As an embodiment, the transmitter 210 may apply the voltage to the piezoelectric transmission layer 212 through a first transmission electrode 211 and a second transmission electrode 213. A piezoelectric effect may be generated by the voltage applied to the piezoelectric transmission layer 212, and the ultrasonic signal may be generated by changing a thickness of the piezoelectric transmission layer 212 through the piezoelectric effect. The first transmission electrode 211 and the second transmission electrode 213 may be metallized electrodes, e.g., metal coating both surfaces of the piezoelectric transmission layer 212.

The receiver 220 may receive the ultrasonic signal reflected from the object, and may include a piezoelectric material. The piezoelectric material is a ferroelectric polymer, such as polyvinylidene fluoride (PVDF) and polyvinylidene fluoride-trifluoroethylene (PVDF-TrFE) copolymers, polyvinylidene chloride (PVDC) homopolymers and copolymers, polytetrafluoroethylene (PTEFE) homopolymers and copolymers, and diisopropylammonium bromide (DIPAB). However, embodiments are not limited thereto.

The receiver may include a substrate 221, a pixel input electrode 222, a piezoelectric receiving layer 223, a receiving bias electrode 224, and/or the like.

A plurality of pixel sensors 225 generating a current according to the received ultrasonic signal may be disposed on the substrate 221. The plurality of pixel sensors 225 may be disposed in an array form on the substrate 221. As will be described later with reference to FIG. 6, the pixel sensor 225 may include a plurality of thin-film transistors (TFTs), electrical interconnection traces, diodes, capacitors, and/or the like as a pixel circuit. The pixel sensor 225 may convert a charge generated in the piezoelectric receiving layer 223 closest to the pixel sensor 225 into an electrical signal. Each of the plurality of pixel sensors 225 may include a pixel input electrode 222 that electrically connects the piezoelectric receiving layer 223 to the pixel sensors 225.

An array of the pixels PXnm described above with reference to FIG. 2 and an array of the pixel sensors 225 may be disposed in regions that do not overlap each other.

The ultrasonic signal reflected from a surface exposed at the platen 230 may be changed to electric charges localized by the piezoelectric receiving layer 223. The charges are collected by the pixel input electrodes 222 and transferred to the pixel sensors 225. The charges may be amplified by the pixel sensors 225 and output to the ultrasonic sensor controller 300.

The receiving bias electrode 224 may be disposed on a surface of the piezoelectric receiving layer 223 that is adjacent to the platen 230. However, embodiments are not limited thereto. The receiving bias electrode 224 may be a metalized electrode and may be grounded or biased to control a current flowing through a TFT array.

The platen 230 may be a material that may be acoustically coupled to the receiver 220. For example, the platen 230 may be formed of plastic, ceramic, glass, and/or the like.

Thicknesses of each of the piezoelectric transmission layer 212 and the piezoelectric receiving layer 223 may be selected to be suitable for generating and receiving the ultrasonic signals. For example, the thickness of the piezoelectric transmission layer 212 made of PVDF may be about 28 μm and the thickness of the piezoelectric receiving layer 223 made of PVDF-TrFE may be about 12 μm. However, embodiments are not limited thereto.

The ultrasonic sensor 200 according to some exemplary embodiments may further include an acoustic delay layer disposed between the transmitter 210 and the receiver 220. The acoustic delay layer may adjust an ultrasonic signal timing and may electrically insulate the transmitter 210 and the receiver 220 at the same time.

As described above with reference to FIG. 3, the transmitter 210, the receiver 220, and the platen 230 of the ultrasonic sensor 200 may be disposed in a stacked manner, but embodiments are not limited thereto.

The ultrasonic sensor 200 may be large enough to simultaneously sense fingerprints from at least two objects, for example, multiple fingers of a user.

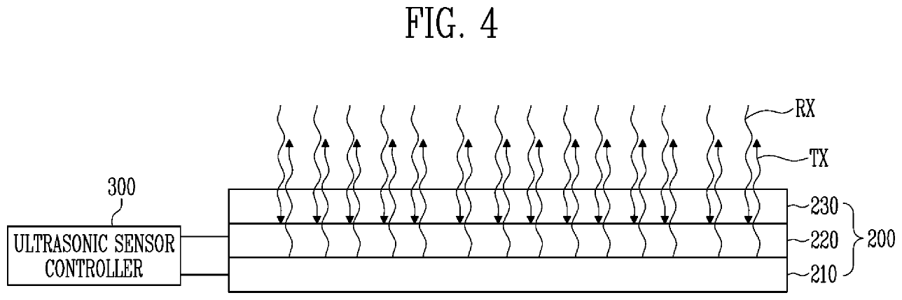

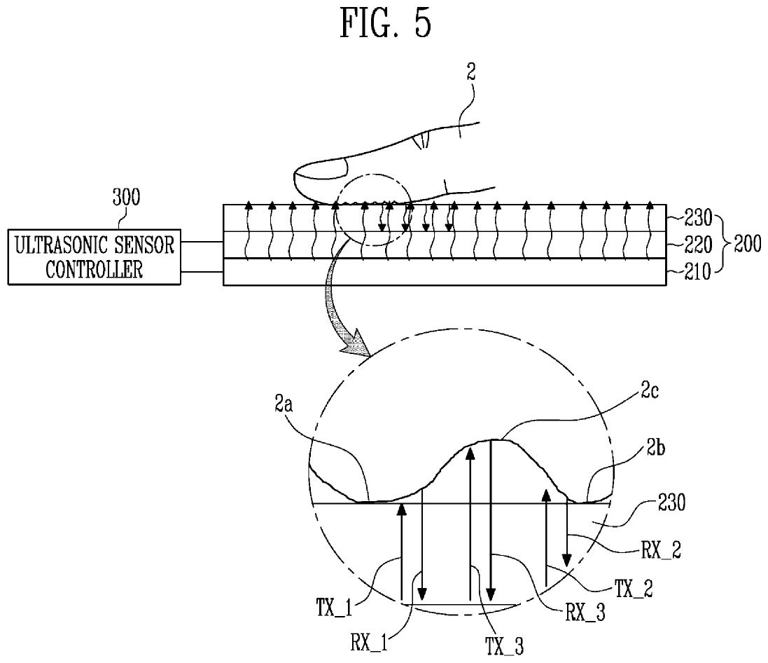

FIG. 4 is a diagram illustrating transmission and reception of ultrasonic signals according to some exemplary embodiments. FIG. 5 is a diagram illustrating transmission and reception of ultrasonic signals when an object exists in FIG. 4 according to some exemplary embodiments.

Referring to FIG. 4, the ultrasonic sensor controller 300 according to an embodiment may be electrically connected to the transmitter 210 and the receiver 220 included in the ultrasonic sensor 200.

The ultrasonic sensor controller 300 may supply a signal for controlling a timing so that the transmitter 210 generates the ultrasonic signal TX to the transmitter 210. For example, the ultrasonic sensor controller 300 controls the ultrasonic sensor 200 by starting and stopping an operation of the transmitter 210 during a preset interval of time. As the preset interval of time is set shorter, the accuracy of the ultrasonic sensor may increase. In other words, the present interval of time and the accuracy of the ultrasonic sensor may have an inverse (or negative) relationship. The transmitter 210 transmits the ultrasonic signals TX moving to the platen 230 through the receiver 220, and the transmitted ultrasonic signals TX are transmitted to the surface exposed to the outside from the platen 230.

When the ultrasonic signals TX are reflected from the object, the reflected ultrasonic signals RX may move to the receiver 220. The receiver 220 may supply the ultrasonic signals RX to the ultrasonic sensor controller 300.

Referring to FIG. 5, when the object is a finger of a user 2, a part of the ultrasonic signal is reflected at an interface of the finger of the user 2. The finger of the user 2 generally includes a fingerprint. In addition, the fingerprint included in (or on) the finger of the user 2 is configured of a plurality of fingerprint ridges 2a and 2b and a plurality of fingerprint valleys 2c.

First ultrasonic signals TX_1 and TX_2, which are part of the ultrasonic signals transmitted to the outside of the platen 230, may be absorbed or scattered and may be reflected again by the fingerprint ridges 2a and 2b that are in contact with the platen 230. At this time, reflected second ultrasonic signals RX_1 and RX_2 may reach the receiver 220.

Third ultrasonic signal TX_3, which is another part of the ultrasonic signals transmitted to the outside of the platen 230, may be reflected at a space that is in contact with the exposed surface of the platen 230, e.g., the valley 2c between the fingerprint ridges 2a and 2b, and a reflected fourth ultrasonic signal RX_3 may reach the receiver 220. Although FIG. 5 shows one third ultrasonic signal TX_3 and one fourth ultrasonic signal RX_3, this is for convenience of description, and embodiments are not limited thereto.

The second ultrasonic signals RX_1 and RX 2 reflected from the fingerprint ridges 2a and 2b and the fourth ultrasonic signal RX_3 reflected from the valley 2c of the fingerprint of the user 2 may be reflected at different intensities.

The ultrasonic sensor controller 300 may generate and output a sensing value, which may be a digital value for detecting the movement (or presence) of the object, by sampling the ultrasonic signals continuously over time.

FIG. 6 is a block diagram illustrating the ultrasonic sensor controller 300 and the pixel sensor 225 according to some exemplary embodiments.

Referring to FIG. 6, the ultrasonic sensor controller 300 according to some exemplary embodiments may include a sensing controller 310, a selector 320, a pixel reader 330, and/or the like.

The sensing controller 310 may control an operation timing of the selector 320 based on an instruction signal input from the central controller 400 and output the sensing value based on the pixel signal. The pixel signal may refer to a signal that the pixel reader 330, which will be described later, reads and outputs a current output from the pixel sensor 225. The sensing controller 310 may include a signal generator that outputs a clock signal and a scan start signal, and an analog-digital converter (hereinafter, an ADC) for converting an analog signal into a digital value.

For example, when a first instruction signal corresponding to the authentication mode is input, the sensing controller 310 may control the operation timing of the selector 320 so that the selector 320 sequentially outputs the scan signal to the plurality of scan lines. When a second instruction signal corresponding to the authentication completion mode is input, the sensing controller 310 may control the operation timing of the selector 320 so that the selector 320 sequentially outputs the scan signal only to odd-numbered (e.g., 2n-1, where n is natural number) scan lines or even-numbered (e.g., 2n) scan lines among the plurality of scan lines S1 to Sn. However, embodiments are not limited thereto.

As another example, the sensing controller 310 receives a plurality of pixel signals corresponding to a selected scan line among the plurality of scan lines S1 to Sn, converts each of the plurality of pixel signals into a digital value, and outputs the sensing value, which is a digital value, to the central controller 400. However, embodiments are not limited thereto.

The selector 320 may sequentially output the scan signal to the plurality of scan lines S1 to Sn. The selector 320 may include a row selection mechanism, a gate driver IC, a shift resister, and/or the like. As described above, the selector 320 may sequentially select the plurality of scan lines S1 to Sn according to timing control of the sensing controller 310 to output the scan signal to the selected scan line, and select the plurality of scan lines S1 to Sn according to a predetermined rule (for example, odd-numbered scan lines S1, S3, . . . , even-numbered scan lines S2, S4, . . . , or the like) to output the scan signals.

The pixel reader 330 may output a pixel signal by reading a current flowing through a plurality of pixel current sensing lines R1 to Rm. The pixel reader 330 may include an amplifier, a capacitor, a multiplexer, and/or the like.

The pixel reader 330 may output a pixel signal for the pixel sensor 225 that generates a current among a plurality of pixel sensors 225 connected to a scan line selected when any one scan line is selected among the plurality of scan lines S1 to Sn, to the sensing controller 310. The sensing controller 310 may digitalize information on the selected scan line and information on the pixel sensor 225 that generates the current, generate digital information, and output the digital information as the sensing value.

The plurality of pixel sensors 225 included in the receiver 220 may be connected to at least one of the plurality of scan lines S1 to Sn and at least one of the pixel current sensing lines R1 to Rm. For example, pixel sensors 225_1 of a first row are connected to the first scan line S1, pixel sensors 225_2 of a second row are connected to the second scan line S2, pixel sensors 225_3 of a third row are connected to the third scan line S3, and pixel is sensors 225 n of an n-th row are connected to the n-th scan line Sn. In addition, pixel sensors 225 corresponding to a first column are connected to the first pixel current sensing line R1, the pixel sensors 225 corresponding to a second column are connected to the second pixel current sensing line R2, and pixel sensors 225 corresponding to an m-th column are connected to the m-th pixel current sensing line Rm. As such, one pixel sensor 225 may be connected to one scan line and one pixel current sensing line. In FIG. 6, the number n of the plurality of scan lines S1 to Sn may be the same as or different from the number m of the plurality of pixel current sensing lines R1 to Rm.

In some embodiments, the pixel sensor 225 may include a peak detection diode that detects a maximum amount of charge localized by the piezoelectric receiving layer 223, a read transistor that generates a corresponding a current when the maximum amount of charge is detected, and/or the like.

FIG. 7 is a flowchart illustrating a user authentication method in the authentication mode according to some exemplary embodiments.

Referring to FIG. 7, the display device 1 according to some exemplary embodiments transmits the ultrasonic signal (S110), receives the ultrasonic signal reflected from the object, for example, the finger of the user 2 (S120), converts the received ultrasonic signal into the digital value and performs an image process on the digital value converted for the user authentication (S130), and obtains the first image of the object (S140).

Next, the display device 1 according to some exemplary embodiments determines whether the first image of the object is the same as the second image stored in the memory 500 (S150). To reflect an error between the images, the display device 1 according to some exemplary embodiments may determine that the first image and the second image are the same when the first image and the second image are similar within a predetermined range. For example, the central controller 400 may calculate a similarity between the first image and the second image, and determine that the object is the finger of the user 2 registered in the display device 2 when the similarity is within a preset error range. However, embodiments are not limited thereto.

As described above, the first image may include first biometric information, the second image may include second biometric information, and the first and second biometric information may be fingerprint information of the finger of the user 2.

When the first image is the same as the second image, the display device 1 according to some exemplary embodiments switches an operation mode from the authentication mode to the authentication completion mode (S160).

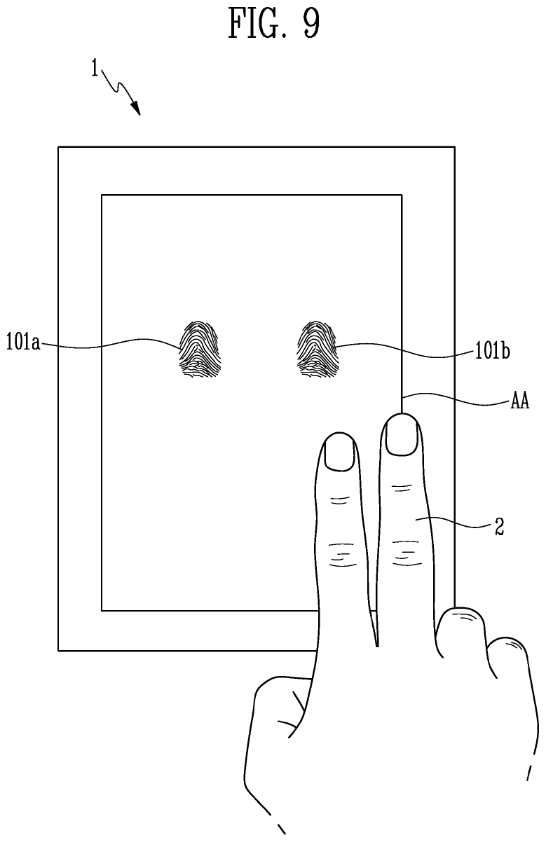

FIG. 8 is a diagram illustrating an embodiment of in which an authentication induction image is displayed according to some exemplary embodiments. FIG. 9 is another embodiment in which an authentication induction image is displayed according to some exemplary embodiments.

Referring to FIG. 8, the central controller 400 included in the display device 1 according to some exemplary embodiments may control the display panel 100 to display a third image in the authentication mode and may control the display panel 100 to display a fourth image different from the third image in the authentication completion mode.

The third image may be at least one authentication induction image 101 for inducing the object to contact the display panel 100. The authentication induction image 101 may refer to an image for inducing the user to appropriately input the biometric information, such as a fingerprint, an iris, and/or a face, to the display device 1.

For example, the central controller 400 controls the display panel 100 to display a fingerprint image in the authentication mode as the authentication induction image 101. At this time, the fingerprint image may be displayed on a portion of a display area AA among the display area AA and a non-display area NA of the display panel 100. The non-display area NA may be disposed outside the display area AA, such as disposed around (e.g., surrounding) the display area AA.

When the display device 1 is in the authentication mode, the authentication induction image 101 may always be displayed on the display panel 100. To reduce power consumption, the authentication induction image 101 may be displayed on the display panel 100 when a predetermined condition is satisfied. For example, the predetermined condition may be whether the finger of the user 2 approaches the display device 1 within a predetermined range. For instance, the central controller 400 may calculate a distance between the object and the display panel 100 based on the sensing value, compare the distance with a preset reference distance, and generate the authentication induction image 101 when the distance is equal to or less than the reference distance. The distance between the object and the display panel 100 may be calculated using a time taken for the ultrasonic signal to be returned from the object, a speed of the ultrasonic signal, which may be stored in the memory 500 in advance.

To reduce power consumption and provide convenience to the user, a position where the authentication induction image 101 is displayed may be determined according to a position of the finger of the user 2 existing on (or near) the display panel 100.

For example, the central controller 400 may control the display panel 100 to calculate coordinates p(x, y) on the display panel 100 corresponding to the position of the object based on the sensing value and display the authentication induction image 101 at the coordinates p(x, y) on the display panel 100. Here, a method of calculating the coordinates p(x, y) may be the same as described above with reference to FIG. 7.

To provide convenience to the user and reduce an error, the authentication induction image 101 may have a predetermined boundary area 102 based on the coordinates p(x, y) on the display panel 100 corresponding to the position of the object.

To further enhance security, two or more authentication procedures may be required to be performed, and a plurality of authentication induction images 101 may be generated in correspondence with the plurality of authentication procedures. In addition, the central controller 400 may perform two or more authentication procedures using the plurality of authentication induction images 101.

For example, the central controller 400 may generate a plurality of authentication induction images 101, store the number of authentication induction images 101, control the display panel 100 to display at least one of the authentication induction images 101, and repeatedly perform the authentication operation until the number of times for the authentication operation of authenticating whether the object is the user registered in the display device 1 is equal to the number.

Referring to FIG. 9, a plurality of authentication induction images may be simultaneously displayed in the display area AA of the display panel 100. For example, both of a first authentication induction image 101a and a second authentication induction image 101b may be displayed on the display panel 100. At this time, the user may touch two or more fingers to the displayed authentication induction images to be authenticated.

In some embodiments, a plurality of authentication induction images 101 may be displayed one-by-one on the display panel 100. As such, after any one of the plurality of authentication induction images 101, for example, the first authentication induction image 101a shown in FIG. 9 is displayed and the user touches their finger to the first authentication induction image 101a to be authenticated, another one of the plurality of authentication induction images 101, for example, the second authentication induction image 101b shown in FIG. 9, may be displayed, or another type of authentication induction image.

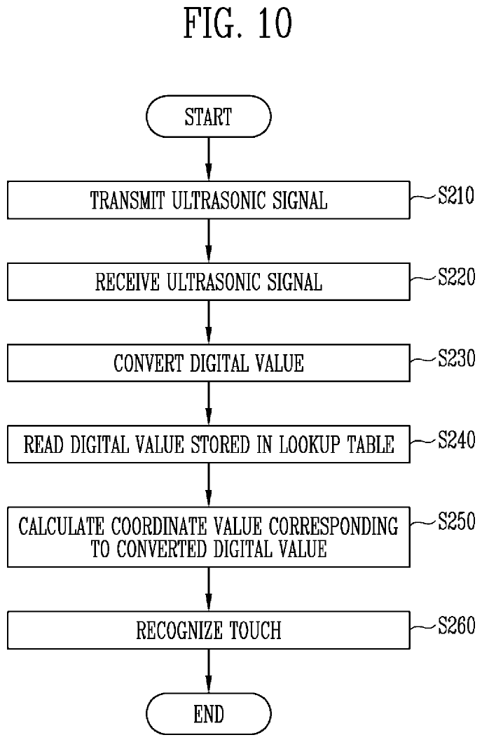

FIG. 10 is a flowchart illustrating a touch recognition method in the authentication completion mode according to some exemplary embodiments.

Referring to FIG. 10, as described above with reference to FIG. 7, the display device 1 according to some exemplary embodiments transmits the ultrasonic signal (S210), receives the ultrasonic signal reflected from the object, for example, the finger of the user 2 (S220), and converts the received ultrasonic signal into a digital value (S230).

In step S240, the display device 1 according to some exemplary embodiments reads digital values stored in the lookup table of the memory 500. The digital values stored in the lookup table may correspond to coordinate values on the display panel 100.

At step S250, the display device 1 according to some exemplary embodiments extracts values corresponding to the digital values converted in step S230 from the digital values stored in the lookup table and calculates (or determines) coordinate values using the extracted values. According to step S260, the display device 1 according to some exemplary embodiments recognizes the touch by the object.

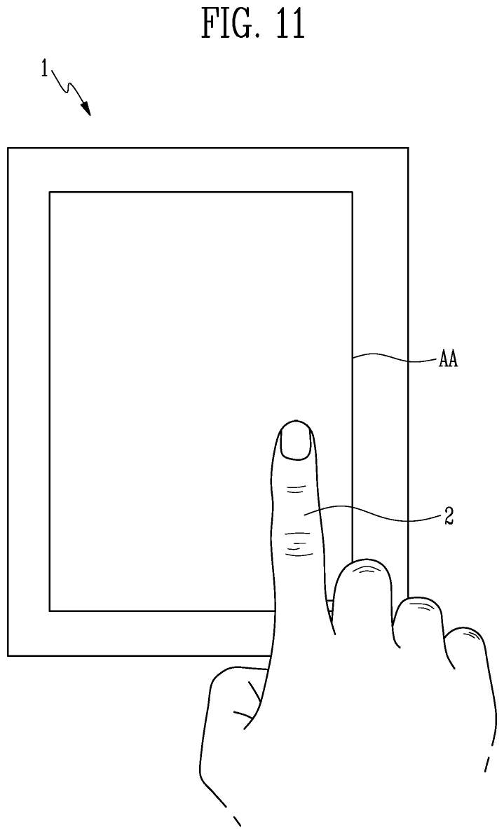

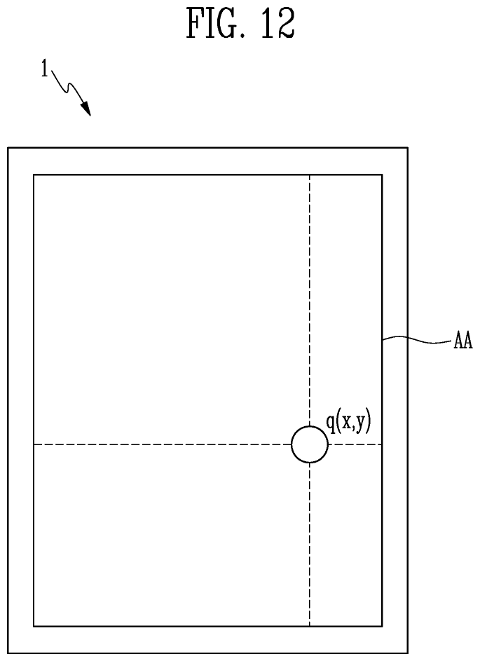

FIGS. 11 and 12 are diagrams illustrating a touch being recognized and touch coordinates being generated according to various exemplary embodiments.

Referring to FIG. 11, the display device 1 senses the finger of the user 2 using the ultrasonic signal in the authentication completion mode. When the finger of the user 2 touches the display panel 100 included in the display device 1, the ultrasonic signal transmitted at the point touched by the finger of the user 2 is reflected from the finger of the user 2 and is incident on the display device 1 again.

Referring to FIG. 12, as described above with reference to FIG. 10, the display device 1 recognizes the touch by the object by calculating the coordinates q(x, y) of the point touched by the finger of the user 2 in the display area AA.

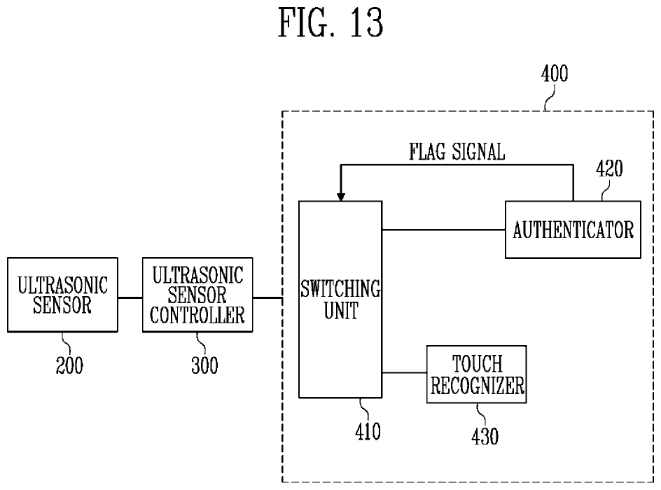

FIG. 13 is a diagram illustrating the central controller 400 according to some exemplary embodiments.

Referring to FIG. 13, the central controller 400 according to some exemplary embodiments may limit the touch recognition of the point touched by the object in the authentication mode, and limit the generation of the first image in the authentication completion mode.

The central controller 400 may include a switching unit 410, an authenticator 420, a touch recognizer 430, and/or the like.

The switching unit 410 may connect any one of the authenticator 420 and the touch recognizer 430 to the ultrasonic sensor controller 300. For example, the switching unit 410 may connect only the ultrasonic sensor controller 300 and the authenticator 420 to each other when the mode is the authentication mode, and may connect only the ultrasonic sensor controller 300 and the touch recognizer 430 to each other when the mode is the authentication completion mode. The switching unit 410 may be implemented with switches, de-multiplexers, and/or the like.

The authenticator 420 may receive the sensing value from the ultrasonic sensor controller 300, generate and recognize the first image, and perform the authentication operation by comparing a similarity between the first image and the second image. The authenticator 420 may include a read out integrated circuit (ROIC), an image processor, and/or the like.

When the authenticator 420 performs the authentication operation and identifies that the object is the user registered in the display device 1, the authenticator 420 may output a flag signal to the switching unit 410. When the flag signal is input to the switching unit 410, the switching unit 410 releases the connection between the ultrasonic sensor controller 300 and the authenticator 420, and connects the ultrasonic sensor controller 300 and the touch recognizer 430 to each other.

The touch recognizer 430 may receive the sensing value, calculate the coordinates of one or more touch points, and recognize the point(s) touched on the display panel 100. The touch recognizer 430 may include a touch driver IC, a processor, and/or the like.

According to some exemplary embodiments, a display device may be capable of reducing cost by performing both a security operation and a touch recognition operation with only an ultrasonic sensor without a separate touch sensor.

According to some exemplary embodiments, a display device that is convenient and portable to a user by miniaturizing and lightening the display device may be provided.

Although certain exemplary embodiments and implementations have been described herein, other embodiments and modifications will be apparent from this description. Accordingly, the inventive concepts are not limited to such embodiments, but rather to the broader scope of the accompanying claims and various obvious modifications and equivalent arrangements as would be apparent to one of ordinary skill in the art.

What is claimed is:

1. A display device comprising:
a display panel configured to display an image;
an ultrasonic sensor configured to sense an object interacting with the display panel using an ultrasonic signal;
an ultrasonic sensor controller configured to:
receive an instruction signal to control an operation of the ultrasonic sensor; and
output a sensing value corresponding to the sensed object; and
a central controller configured to:
output the instruction signal according to one of an authentication mode and an authentication completion mode; and
control the display panel based on the sensing value,
wherein, in response to a mode being the authentication mode, the central controller is further configured to:
is generate a first image of the object based on the sensing value; and
determine whether the object corresponds to a user registered to the display device based on a comparison of the first image with a predefined second image, and
wherein, in response to the mode being the authentication completion mode, the central controller is further configured to recognize a point touched on the display panel by the object based on the sensing value.

2. The display device of claim 1, wherein the central controller is further configured to:
determine a similarity between the first image and the predefined second image; and
determine, in response to the determined similarity being within a preset error range, that the object corresponds to the user registered to the display device.

3. The display device of claim 2, wherein:
the first image comprises first biometric information; and
the predefined second image comprises second biometric information of the user registered to the display device.

4. The display device of claim 3, wherein the first and second biometric information are fingerprint information.

5. The display device of claim 1, wherein the ultrasonic sensor comprises:
a transmitter configured to transmit the ultrasonic signal; and
a receiver configured to receive the ultrasonic signal reflected from the object, the receiver comprising one or more pixel sensors configured to generate a current according to the received ultrasonic signal.

6. The display device of claim 5, wherein:
the ultrasonic sensor controller comprises:
a selector configured to sequentially output a scan signal to a plurality of scan lines;
a pixel reader configured to:
determine a current of a plurality of pixel current sensing lines; and
output a pixel signal; and
a sensing controller configured to:
control an operation timing of the selector based on the instruction signal; and
output the sensing value based on the pixel signal; and
each of the plurality of pixel sensors is connected to at least one of the plurality of scan lines and at least one of the pixel current sensing lines.

7. The display device of claim 6, wherein:
in response to reception of a scan signal by one of the plurality of scan lines, the pixel reader is configured to output a pixel signal for a pixel sensor among the plurality of pixel sensors, the pixel sensor being connected to the one of the plurality of scan lines; and
the sensing controller is configured to convert the pixel signal corresponding to the pixel sensor into a digital value to output the sensing value.

8. The display device of claim 1, wherein the central controller is configured to:
control the display panel to display a third image in the authentication mode; and
control the display panel to display a fourth image in the authentication completion mode, the fourth image being different from the third image.

9. The display device of claim 8, wherein the third image is at least one authentication induction image configured to induce the object to contact the display panel.

10. The display device of claim 9, wherein the central controller is further configured to:
determine a distance between the object and the display panel based on the sensing value;
compare the distance with a preset reference distance; and
generate the authentication induction image in response to the distance being less than or equal to the reference distance.

11. The display device of claim 10, wherein the central controller is further configured to:
determine coordinates corresponding to a position of the object based on the sensing value; and
control the display panel to display the authentication induction image at the coordinates.

12. The display device of claim 11, wherein the authentication induction image is an image comprising a predetermined boundary region based on the coordinates.

13. The display device of claim 9, wherein:
the at least one authentication induction image is one of a plurality of authentication induction images; and
the central controller is further configured to:
generate the plurality of authentication induction images;
store the plurality of authentication induction images;
control the display panel to display at least one of the plurality of authentication induction images; and
perform an authentication operation repeatedly until a number of times the authentication operation is performed equals a number of the plurality of authentication induction images.

14. The display device of claim 1, wherein the central controller is configured to:
perform touch recognition for a point touched by the object only in the authentication mode; and
generate the first image only in the authentication completion mode.

15. The display device of claim 1, wherein the central controller is further configured to:
determine whether the display panel is touched by the object in the authentication mode; and
generate the first image based on the sensing value in response to the display panel being touched by the object.

16. An apparatus comprising:
at least one processor; and
at least one memory comprising a predefined image and one or more sequences of one or more instructions that, in response to being executed by the at least one processor, cause the apparatus at least to:
receive an ultrasonic signal in association with one of an authentication mode and an authentication completion mode;
sense interaction of an object with the apparatus based on reception of the ultrasonic signal;
generate a sensing value corresponding to the interaction; and
generate a display panel control signal based on the sensing value,
wherein, in association with the authentication mode, the apparatus is further caused at least to:
generate an image of the object based on the sensing value; and
determine whether the object corresponds to a user registered to the apparatus based on a comparison of the image with the predefined image, and
wherein, in association with the authentication completion mode, the apparatus is further caused at least to recognize a point of interaction of the object with the apparatus based on the sensing value.

17. The apparatus of claim 16, wherein:
the apparatus is further caused at least to transmit the ultrasonic signal towards the object; and
the ultrasonic signal is reflected from the object prior to reception.

18. The apparatus of claim 16, wherein each of the image and the predefined image corresponds to biometric information of the user.

19. The apparatus of claim 16, wherein:
the apparatus is further caused at least to determine a distance between the object and the apparatus based on the sensing value; and
generation of the display panel control signal is in response to the distance being less s than or equal to a predetermined distance, the display panel control signal being configured to cause display of an authentication induction image configured to induce the object to interact with the apparatus.

20. The apparatus of claim 19, wherein:
the apparatus is further caused at least to determine coordinates of the interaction based on the sensing value; and
the display panel control signal comprises information corresponding to the coordinates.
